(19) United States
(12) Patent Application Publication
(10) Pub. No.: US 2013/0055537 A1
(43) Pub. Date: Mar. 7, 2013

(54) METHOD AND APPARATUS FOR HELICAL CUTTING OF A TUBULAR FILM

(71) Applicants: Ole-Bendt Rasmussen, Walchwil (CH); Nikolai Wettergren Rasmussen, Walchwil (CH)

(72) Inventors: Ole-Bendt Rasmussen, Walchwil (CH); Nikolai Wettergren Rasmussen, Walchwil (CH)

(21) Appl. No.: 13/511,729

(22) PCT Filed: Nov. 22, 2010
(86) PCT No.: PCT/EP2010/067952

§ 371 Date: Nov. 15, 2012

(30) Foreign Application Priority Data
Nov. 24, 2009 (GB) 0920495.9

(51) Int. Cl. B26D 3/00; B26D 1/02

(52) U.S. Cl. 29/2.14; 29/2.25

(57) ABSTRACT

A method of helically cutting a tubular film of thermoplastic material, in which a film in lay flat form, discharged from a reel, is brought to rotate around the middle axis of the film by means of rotating unwind devices, and while the rotating tube proceeds over the mandrel it is cut to non-tubular form by a knife, the position of which is fixed in relation to the surroundings, and the cut film is taken off from the mandrel, characterized in that the inflated film while being forwarded towards the mandrel or while it passes the upstream end of the mandrel, or both, is supported by driven support means placed around the outside of the tubular film, the movement of the support means being adapted to fit with the combined rotation and forwarding movement of the film.

### RELATED APPLICATIONS

This application is a 35 U.S.C. §371 national phase application, claiming priority to and the benefit of PCT/EP2010/067952 filed 22 Nov. 2010 (Nov. 22, 2010), which claims priority to and the benefit of GB 0920495.9 filed 24 Nov. 2009 (Nov. 24, 2009).

### BACKGROUND OF THE INVENTION

1. Field of the Invention

The method according to the present invention is characterized in that the inflated film while being forwarded towards the mandrel or while it passes the upstream end of the mandrel, or both, is supported by moving support means placed around the outside of the tubular films, in a generally circular arrangement.

2. Description of the Related Art

In the manufacture of crosslaminates of oriented films, made from orientable polymer material, a step in the process normally is helically cutting of a tubular film which has been oriented mainly in its longitudinal direction. Hereby there is formed a non-tubular film with its main direction forming an angle higher than 0° and lower than 90° to the new longitudinal direction of the film, e.g. a 45° orientation. Two or more such biased oriented films can then be continuously laminated with their main directions of orientation crossing each other. A longitudinally oriented film can also be included in the lamination.

The entire process of producing crosslaminates, from extrusion to and including the lamination, and several problems in this process, is extensively described in WO081006858 (Rasmussen). The polymer compositions of film which have been industrially used in crosslaminates have mainly been based on HDPE, LLDPE (and blends of the two) or crystalline PP.

The basis patent on applying helical cutting of oriented tubular film in the manufacture of crosslaminates is described in GB816607 (Rasmussen) which claims priority from 1954. A particular practical method of carrying out the helical cutting, and apparatus for such purposed are known, e.g. from U.S. Pat. No. 5,248,366 (Rasmussen) which claims the method, and U.S. Pat. No. 5,361,469 20 (Rasmussen) which claims the apparatus. The descriptions in the two patents are practically identical.

According to that method the unwound lay flat film leaves the unwinding devices in rotating state, and is inflated by air to true tubular (circular cylindrical) shape. The tube is stiffened by the pressure of the air. It is forwarded to and proceeds over a hollow cutting mandrel, which has a diameter slightly smaller than the diameter of the inflated tube. The air for inflation is blown through the hollow mandrel into the tubular film, and flows out through the narrow space between the mandrel surface and the film. Hereby the film moving over the mandrel becomes air lubricated.

The tubular film rotates together with the unwinding means, thus every point on the tubular film moves in a helical path over the surface of the mandrel. A knife in steady position in relation to the mandrel cuts the film to non-tubular shape, and the film is discharged from the mandrel. Its new longitudinal direction will form an angle to its original longitudinal direction.

These steps in the known helical cutting process are also used in connection with the present invention, and they are described more precisely in the introduction to the main method claim. It will be seen that there are two alternative ways, marked a) and b), to achieve the rotation of the tubular film around its axis. A study of the drawings in the above mentioned US patents will facilitate the understanding of the claim language in this connection. The route a) is illustrated in FIG. 1 of each patent, while the route b) is illustrated in FIG. 2 and FIG. 3 of each patent.

The method and apparatus according to the above mentioned US patents further comprise means for positively controlling the advance and expansion of the lay flat tube in the inflation zone. As described in the said patents, these means are driven and consist either of a pair of driven belts, or two arrays of parallel, driven belts, or two arrays of parallel rollers having a small diameter (at least the downstream rollers in each array being driven), or for a relatively narrow lay-flat tube simply one pair of driven barrel like rollers. In each case these driven support means convey the film in such a way that it expands from the lay-flat form to an oval form. Having left the support means, the film gradually changes while unsupported from the oval to a circular shape under the influence of the internal air pressure. In connection with the present invention, such conveying means are only optional, however in some cases preferable.

An improvement of the helical cutting longitudinally oriented tubular polymer film is mentioned in WO09/090,208 (Rasmussen) and is the subject of WO20101015512 which had not been published on or before the priority date of the present application. According to this improvement, the tubular lay flat film is longitudinally stretched in the “tumbling” unwind stand between the discharge from the reel and the start of the inflation, and the film is stabilized after the helical cutting. In connection with the present invention, the stretching in the “tumbling” unwind stand is also optional, but as it shall be explained later, the combination of the two inventions may be very advantageous when making particularly thin films with a uniaxial direction of orientation on the bias.

The method of helical cutting described above (not considering the stretching in the “tumbling” unwinder) has been used industrially and with success for more than 20 years, however problems have appeared when the gauge of the film to be cut has been lower than about 20-30 micron or the radius of the inflated tubular film tube has been high. In such cases it was found that a too high air pressure inside the tube was needed for sufficient stiffening of the film, “too high” meaning that in spite of the described conveying means the pressure tended to produce an irregular transverse stretching or even splitting of the tubular film. This is a serious limitation in the use of crosslamination technology, since the increase in strength properties which crosslamination provides, ideally should be used to save raw materials by producing very thin but still adequately strong film material.

### SUMMARY OF THE INVENTION

The method according to the present invention is characterized in that the inflated film while being forwarded towards the mandrel or while it passes the upstream end of the mandrel, or both, is supported by moving support means placed around the outside of the tubular films, in a generally circular arrangement.

By this precaution the torque effect on the inflated tube can be very reduced, and the pressure inside the tube can be essentially reduced. Furthermore the accuracy of the helical cutting is significantly increased, so that scrap formed by edge trim can be reduced. This is a matter of economical importance.

Preferably the support means, which surround the inflated tube, consist in a circular array of support devices, either wheels, short rollers, or belts, which array on the whole rotates with the same rotational velocity as that of the rotating unwind devices, at the same time as each driven support device forwards the film in its axial direction. This means that, the axis of each wheel or roller which is included in this conveying system, at least at its downstream end is perpendicular to the axis of the inflated tubular film.

In each embodiment, the velocity of each support means should preferably be driven by mechanical means different from the film itself, and the effect is best when these mechanical means act with a velocity slightly higher than the velocity at which the film is delivered to the inflation zone. The purpose is to tenter the film which is slides on the support means, thereby assisting in the forwarding of the tube.

### BRIEF DESCRIPTION OF THE DRAWINGS

The invention shall now be explained in further detail with reference to principal, sketchy drawings.

FIG. 1 shows the downstream end of a circular array of driven support means in form of driven belts at the location where the discharge the tubular film. It is a view in sections through the axis of 10 short rollers, which carry the belts. The drive of the belts comes from the rollers shown in FIG. 2. The sketch FIG. 1 also shows, in cross section, the inflated tubular film and a location on a conical tip on the hollow mandrel.

FIG. 2 shows the upstream end at the same circular array of driven belts, including the short rollers which drive the belts and, very schematically, means to drive each short roller. The tubular film, which at this stage of the process normally will be partly but not fully inflated, is not shown.

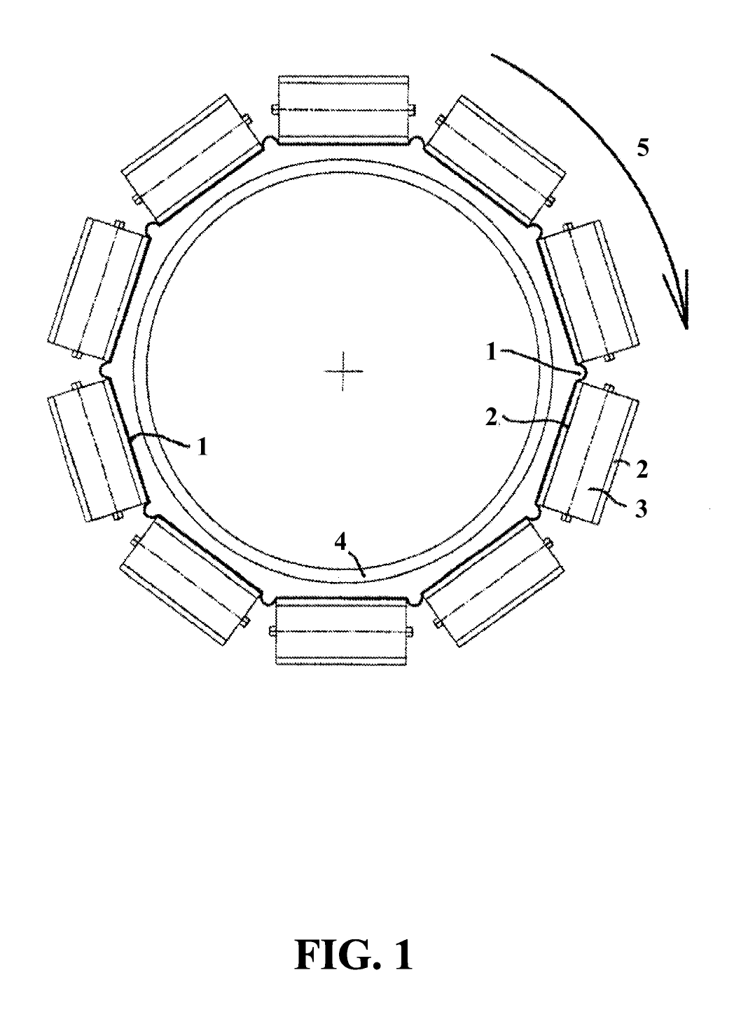

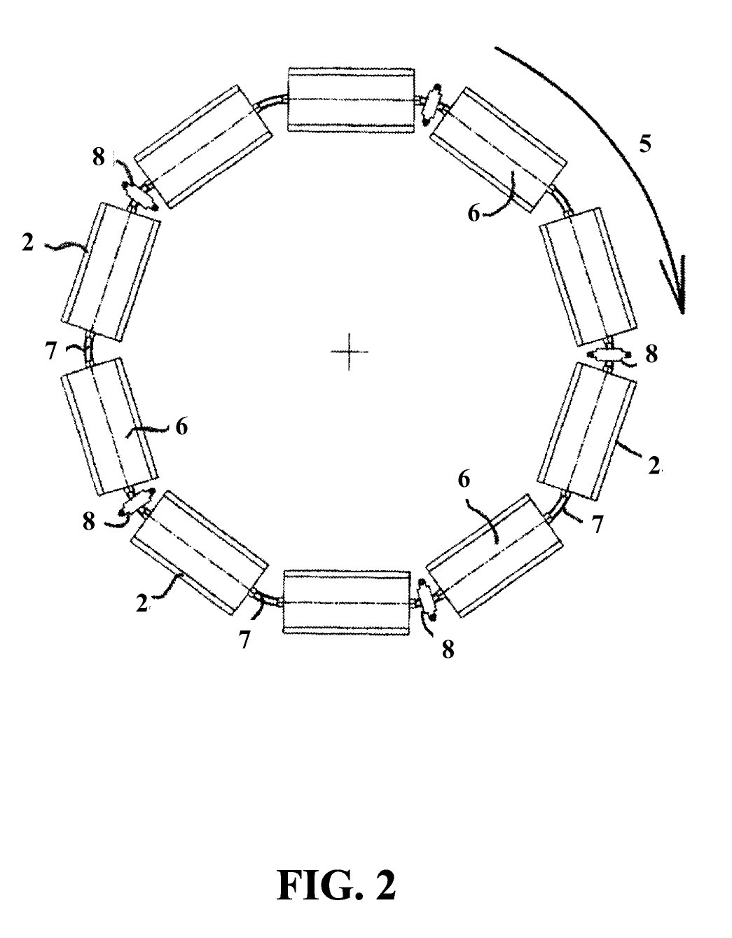

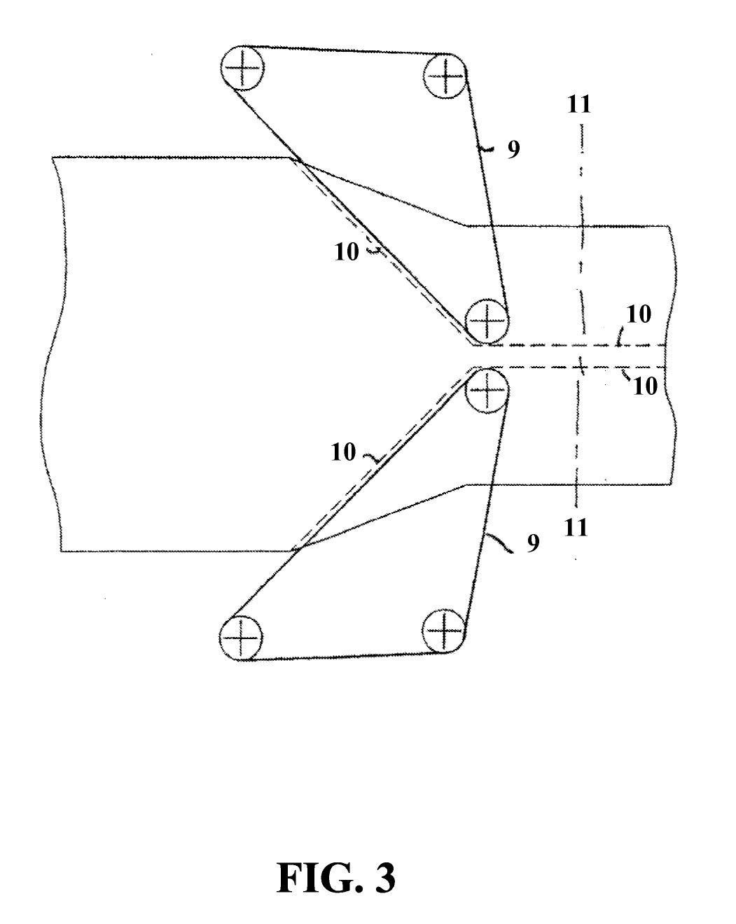

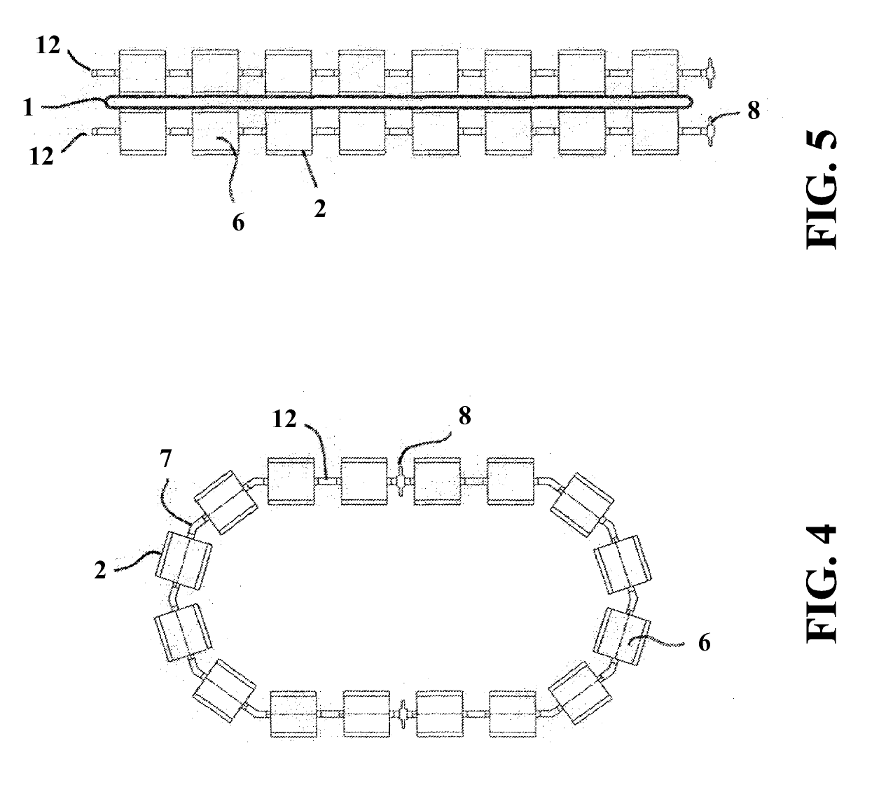

FIG. 1 and FIG. 2 are best studies in conjunction with FIG. 1 and FIG. 2 of U.S. Pat. No. 5,248,366 or of U.S. Pat. No. 5,361,469.

FIG. 3 illustrates in schematical way, the conveyed inflation of a gusseted tubular film to tubular shape, each gusset being supported and conveyed by means of conveyor straps arranged inside the gusset.

FIG. 4 shows a variation of the arrangement represented by FIG. 2 namely a construction in which the upstream end of driven support belts forms an oval array.

FIG. 5 shows a further variation of the upstream end of driven support belts, in which the oval array shown in FIG. 4 has degenerated into two plane arrays facing each other and very close to each other.

### DETAILED DESCRIPTION OF THE INVENTION

The method according to the present invention is characterized in that the inflated film while being forwarded towards the mandrel or while it passes the upstream end of the mandrel, or both, is supported by moving support means placed around the outside of the tubular films, in a generally circular arrangement.

By this precaution the torque effect on the inflated tube can be very reduced, and the pressure inside the tube can be essentially reduced. Furthermore the accuracy of the helical cutting is significantly increased, so that scrap formed by edgetrim can be reduced. This is a matter of economical importance.

Preferably the support means, which surround the inflated tube, consist in a circular array of support devices, either wheels, short rollers, or belts, which array on the whole rotates with the same rotational velocity as that of the rotating unwind devices, at the same time as each driven support device forwards the film in its axial direction. This means that, the axis of each wheel or roller which is included in this conveying system, at least at its downstream end is perpendicular to the axis of the inflated tubular film.

In each embodiment, the velocity of each support means should preferably be driven by mechanical means different from the film itself, and the effect is best when these mechanical means act with a velocity slightly higher than the velocity at which the film is delivered to the inflation zone. The purpose is to tenter the film which is slides on the support means, thereby assisting in the forwarding of the tube.

When the support means are belts, which at the downstream end are arranged as a circular array, there exist different options for the arrangement of the belts at their upstream end. One option is that they here also are arranged as a circular array. This type of conveying, illustrated in FIG. 2, is suitable, when the film at the beginning of the inflation has been conveyed by the known means, which have been described above.

Alternatively, the array of belts may in the upstream end be arranged as an oval array. This is illustrated in FIG. 4. In this manner the conveying belts of the present invention may be located closer to the known conveying means shown in the above mentioned US patents.

A third option, illustrated in FIG. 5, is that the array of belts in the upstream end is arranged as two plane arrays, which face each other, and are in close proximity to each other. In this way they can support the film during practically its entire route from lay flat to fully inflated tube.

The circular array of support means, and the rotating unwind devices may form one integral stand, in other words may be built together, or alternatively the circular array of support means may be arranged in a separate stand, which is rotated synchronously with the rotating unwind device.

Alternatively the support means which surround the inflated tubular film, may each be located in a fixed position. In that case the support means must be mounted at an angle, so that they guide the inflated film under an angle which corresponds to the angle of cutting. However, normally this embodiment of the invention is not quite as practical as the embodiment using a rotating circular array of driven wheels, short rollers or belts.

Also the support means are preferably close together so that at the position where the inflated film leaves the support means, the distance from middle to middle of each pair of adjacent support means is at the highest 30 cm, preferably at the highest 20 cm, and more preferably at the highest 10 cm. A further embodiment of the invention is characterised in that the upstream end of the mandrel is conical, and the conveying effect of the support means is confined to or ends in a zone over said conical part. Hereby the effect of the torque on the inflated tubular film can be reduced best possible.

A still further embodiment is characterised in that the mandrel as a whole rotates with the same rotational velocity as the unwinding devices.

Alternatively, and more practically a downstream part of the mandrel including a conical end of the latter, rotates with the same rotational velocity as the rotating unwind devices, while the rest of the mandrel including the position where the cutting takes place, is stationary. The reason for rotating at least the tip of the mandrel with the same velocity as the unwinding devices, is that a) the space between the mandrel and the tubular film moving over the mandrel under air lubrication should preferably be as narrow as possible, b) the driven support means should be as close to the tip of the mandrel as possible, and should preferably overlap with the conical tip of the mandrel, c) the tubular film will normally not be ideally cylindrical immediately after it has left the driven support means. As a consequence, a part of the inflated tubular film will normally touch the mandrel on or near the tip of the mandrel, and in spite of the air lubrication this can influence the accuracy of the helical cutting and/or reduce the speed at which the process can be carried out. However, when at least a downstream part of the mandrel rotates with the same velocity as the inflated tube, such touching does little harm.

A further embodiment of the invention is characterised in that the lay flat film to be used is a gusseted film, and during the transformation of the film from gusseted lay flat shape to true tubular shape, one or more driven conveyor straps arranged in each gusset conveys the inside fold of the gusset. This guidance of the film, which schematically is illustrated in FIG. 3, is an additional help to reduce the effect of the torque on the inflated tubular film. The conveyor straps should preferably move slightly faster than the film. This precaution can also be practised independently of the conveying by the support means, placed around the outside of the tubular film, therefore is considered an invention on its own merits.

Thus, this independent aspect of the invention can with advantage be combined with the invention disclosed in the above mentioned US patent, characterized in that the lay flat film to be used is a gusseted film, and during the transformation of the film from gusseted lay flat shape to true tubular shape, one or more driven conveyor straps arranged in each gusset conveys the inside fold of the gusset.

As it would be understood, the lay flat tubular film to be used in the process will normally be oriented mainly in its longitudinal direction. However, it can also be oriented mainly under an acute angle to its longitudinal direction, as this can be achieved by a screwing haul-off from the circular extrusion die. If e.g. the starting tubular film has a helical main orientation, which forms an angle of 30° to its longitudinal direction (which is obtainable in practice) and the helical cutting takes place under 60°, the resultant film may be oriented under 90° to its longitudinal direction.

The invention also comprises any apparatus suitable for carrying out each of the embodiments of the method. Suitable apparatuses include an apparatus for helically cutting a flexible tubular film of substantially predetermined diameter into a flat strip comprising a reel of lay flat tubular film, a rotating unwind device for discharging the lay flat tube from the reel, the unwind device being arranged to rotate either a) by installing the reel in an unwind stand which makes the axis of the reel rotate around its middle point, while the lay flat film is discharged from the reel in a discharge zone extending parallel with its rotating axis; or b) by keeping the axis of the reel fixed and unwinding the lay flat film by means of spinning devices rotating around the reel, whereby the discharge zone parallel with the axis of the reel is brought to spin around the reel together with the spinning devices, and the lay flat film is hauled off over one end of the reel, such that it will rotate around its middle axis with the same rotational velocity as that of the spinning devices; supply means for supplying the flattened tubular films to a first position, means at said first position for advancing said flattened film at a substantially predetermined velocity from said first position to an expansion zone where it is expanded from said flattened form into a circular cylindrical form, the axis of the cylinder being aligned with the axis of rotation of the rotating unwind device, a generally circular cylindrical mandrel over which the expanded cylindrical tubular film is passed axially thereof, cutting means for helically cutting the cylindrical tubular film passing along the mandrel into a flat strip, and means for removing the helically cut strip from the mandrel at an angle to the mandrel axis, wherein said mandrel is hollow with an external diameter slightly less than the diameter of the expanded tubular film, and comprising means in said expansion zone for supplying air continuously through said hollow mandrel in the direction of said first position under a pressure sufficient to inflate said flattened tubular film into a stiff generally circular cylindrical tube that makes a sliding fit with said mandrel and resists deformation during the helical cutting thereof, characterized by comprising moveable support means placed around the outside of the tubular film in a generally circular arrangement close upstream of or at the upstream end of the mandrel arranged to drive the cylindrical surface of the said tube with an axial and circumferential component of movement aligned with the axial movement of the film and the rotation of the rotating unwind device. The apparatus may also be characterized in that the moveable support means consist in a circular array of support devices which are mounted such that the array on the whole rotates with the same rotational velocity as that of the rotating unwind devices. The apparatus may also be characterized in that the array and the rotating unwind devices form one integral stand. The apparatus may also be characterized in that the array is mounted in a separate stand, which is brought to rotate synchronously with the rotating unwind devices. The apparatus may further comprise means for driving the support means, the driving means preferably acting with a component of axial velocity greater than the axial velocity of the film at that point whereby the film slides on the driven support means. The apparatus may also be characterized in that each support means is a wheel or short roller. The apparatus may also be characterized in that each support means is a belt. The apparatus may also be characterized in that the array of belts in the upstream end is arranged as a circular array. The apparatus may also be characterized in that the array of belts in the upstream end is arranged as an oval array. The apparatus may also be characterized in that the array of belts in the upstream end is arranged as two planar arrays facing each other and in close proximity to each other. The apparatus may also be characterized in that at the position where the inflated film leaves the support means, the distance from middle to middle of each pair of adjacent support means is at the highest 30 cm, preferably at the highest 20 cm, and more preferably at the highest 10 cm. The apparatus may also be characterized in that the upstream end of the mandrel is conical, and the conveying effect of the support means is confined to or ends in a zone over said conical part. The apparatus may also be characterized in that the mandrel on the whole rotates with the same rotational velocity as the unwinding devices, while the cutting means are stationary. The apparatus may also be characterized in that a downstream part of the mandrel including a conical end of the latter, rotates with the same rotational velocity as the rotating unwind devices, while the rest of the mandrel including the position where the cutting takes place, is stationary. The apparatus may also be characterized in that the lay flat film to be used is a gusseted film, and in the said expansion zone there are provided one or more conveyor straps arranged in each gusset against which the inside fold of the respective gusset bears, whereby the opening of the gusset is controlled. The apparatus may also further comprises stretching rollers arranged to longitudinally stretch the film between the rotating unwind device and the expansion zone, wherein the stretching rollers are mounted to rotate with the unwind device and about the axis of the rotating unwind device.

In FIG. 1, (1) is the inflated tubular film, corresponding to (10) in the abovementioned US patents. (2) are the conveyor belts and (3) the short rollers, which guide these belts. (4) is the conical tip of the hollow mandrel, corresponding to the “rounded” tip (16) in the US patents. The arrow (5) shows the rotation of the circular array of the support belts and of the hollow mandrel. For the sake of the simplification, the rotating framework, to which the array of short rollers is assembled through bearings, is not shown. This framework should normally be directly connected with the rotating unwind stand (numeral 6 in the US patents).

As it appears from the sketch, the film (1) slightly protrudes outward at the spaces between the belts. However, when it has reached the main body of the mandrel, it will fit with the mandrel except for a few millimetres or centimetres spacing.

In FIG. 2, the short rollers (6) which drive the belts (2) are connected through flexible rods (7), 5 of which are driven from the unwind stand (numeral 6 in the US patents) through endless straps and the strap discs (8). Of course this is only a simplified example of how the rollers (6) can be driven. Like in FIG. 1 the rotating framework to which the array of short rollers are assembled through bearings, is not shown, and this framework should normally be directly connected with the unwinding stand.

In FIG. 3, the unwound lay-flat tube (1) has gussets, the inner folds (10) of which extend almost to its middle. It passes the nip (11) between the two nip rollers in the rotating unwind stand, which in the mentioned US patents also have reference numerals (11). Immediately after this nip, driven guiding straps (9) are fed into the gussets to convey the film material adjacent to the inner fold. They guide this fold outwardly, while the tubular film gradually inflates due to the pressure of air, which is established as shown in FIG. 1 and FIG. 3 of the mentioned two US patents.

In FIG. 4 and FIG. 5, two groups of the short rollers or wheels (6) which drive the support belts (2), are mounted on long shafts (12) and are driven through the strap discs (8). In the oval arrangement shown in FIG. 4, there are also connections through flexible rods (7) like in the circular arrangement shown in FIG. 2. The total number of rollers or wheels (6) at the upstream end of the conveying system, must of course equal the number of rollers or wheels (3) at the downstream end, although that does not appear from the Figures.

The lay flat tubular film (1) is shown in FIG. 5. While it follows the belts (2) it will first become oval, then more and more approach a circular shape, and end as shown in FIG. 1.

While the belts (2) move from the positions shown in FIG. 4 and FIG. 5 to the positions shown in FIG. 1, all or a majority will become twisted (except if they have circular cross-section which is not preferable) and will twist back to the original position on the return path. Thus the belts shown at the two ends in FIG. 4 will twist practically 90°, while the belts at the middle will practically not twist.

This twisting will not harm the conveying effect, since the flat belts during the entire route will be generally tangential to the film they convey during its inflation. However, to hold the twisting flat belts (2) on the rollers or wheels (6)—and (3) in FIG. 1—guiding tracks are required in (6) and (3) and/or in the flat belts (2). For the sake of simplification these tracks are not shown.

We claim:

1. A method of helically cutting a tubular film of thermoplastic material, in which a film in lay flat form, discharged from a reel, is brought to rotate around the middle axis of the film by means of rotating unwind devices, this rotation being established
a) either by installing the reel in an unwind stand which makes the axis of the reel rotate around its middle point, while the lay flat film is discharged from the reel in a discharge zone extending parallel with its rotating axis,
b) or by keeping the axis of the reel fixed and unwinding the lay flat film by means of spinning devices rotating around the reel, whereby the discharge zone parallel with the axis of the reel is brought to spin around the reel together with the spinning devices, and the lay flat film is hauled off over one end of the reel, such that it will rotate its middle axis with the same rotational velocity as that of the spinning devices, and
in each case a) and b), the unwound rotating lay flat film is inflated to true tubular form, whereby the axis of the tube generally coincides with the axis of rotation of the rotating unwind devices, and the rotating tube is forwarded to and proceeding over a mandrel having a diameter slightly lower than the diameter of the inflated tube, this mandrel being hollow and the air for inflation being blown through it, and while the rotating tube proceeds over the mandrel it is cut to nontubular form by a knife, the position of which is fixed in relation to the surroundings, and the cut film is taken off from the mandrel, characterized in that the inflated film while being forwarded towards the mandrel or while it passes the upstream end of the mandrel, or both, is supported by moving support means placed around the outside of the tubular film in a generally circular arrangement close upstream of or at the upstream end of the mandrel.

2. The method according to claim 1, wherein the moving support means consist in a circular array of support devices which are mounted such that the array on the whole rotates with the same rotational velocity as that of the rotating unwind devices.

3. The method according to claim 2, wherein the array and the rotating unwind devices form one integral stand.

4. The method according to claim 2, wherein the array is mounted in a separate stand, which is brought to rotate synchronized with the rotating unwind devices.

5. The method according to claim 1, wherein each support means is driven by mechanical means different from the film itself.

6. The method according to claim 1, wherein each support means is a wheel or short roller.

7. The method according to claim 1, wherein each support means is a belt.

8. The method according to claim 7, wherein the array of belts in the upstream end is arranged as a circular array.

9. The method according to claim 7, wherein the array of belts in the upstream end is arranged as an oval array.

10. The method according to claim 7, wherein the array of belts in the upstream end is arranged as two planar arrays facing each other and in close proximity to each other.

11. The method according to any preceding claim, wherein at the position where the inflated film leaves the support means, the distance from middle to middle of each pair of adjacent support means is at the highest 30 cm.

12. The method according to any of the preceding claims, wherein the upstream end of the mandrel is conical, and the conveying effect of the support means is confined to or ends in a zone over the conical part.

13. The method according to any of the preceding claims, wherein the mandrel on the whole rotates with the same rotational velocity as the unwinding devices.

14. The method according to any of the claims 1-12, wherein a downstream part of the mandrel including a conical end of the latter, rotates with the same rotational velocity as the rotating unwind devices, while the rest of the mandrel including the position where the cutting takes place, is stationery.

15. The method according to any of the preceding claims, wherein the lay flat film to be used is a gusseted film, and during the transformation of the film from gusseted lay flat shape to true tubular shape, one or more driven conveyor straps arranged in each gusset conveys the inside fold of the gusset.

16. The method according to any of the preceding claims, wherein the lay flat film to be used is oriented in its longitudinal direction.

17. The method according to any of the preceding claims, wherein the lay flat film to be used is oriented under an acute angle to its longitudinal direction.

18. The method according to any of the claims 1-12, wherein between the rotating unwind and the zone of inflation the lay flat film is oriented in its longitudinal direction by stretching rollers, the axis of which rotate together with the rotation of the unwind stand.

19. An apparatus for helically cutting a flexible tubular film of substantially predetermined diameter into a flat strip comprising a reel of lay flat tubular film, a rotating unwind device for discharging the lay flat tube from the reel, the unwind device being arranged to rotate either
a) by installing the reel in an unwind stand which makes the axis of the reel rotate around its middle point, while the lay flat film is discharged from the reel in a discharge zone extending parallel with its rotating axis; or
b) by keeping the axis of the reel fixed and unwinding the lay flat film by means of spinning devices rotating around the reel, whereby the discharge zone parallel with the axis of the reel is brought to spin around the reel together with the spinning devices, and the lay flat film is hauled off over one end of the reel, such that it will rotate around its middle axis with the same rotational velocity as that of the spinning devices;
supply means for supplying the flattened tubular films to a first position, means at the first position for advancing the flattened film at a substantially predetermined velocity from the first position to an expansion zone where it is expanded from the flattened form into a circular cylindrical form, the axis of the cylinder being aligned with the axis of rotation of the rotating unwind device, a generally circular cylindrical mandrel over which the expanded cylindrical tubular film is passed axially thereof, cutting means for helically cutting the cylindrical tubular film passing along the mandrel into a flat strip, and means for removing the helically cut strip from the mandrel at an angle to the mandrel axis, wherein the mandrel is hollow with an external diameter slightly less than the diameter of the expanded tubular film, and comprising means in the expansion zone for supplying air continuously through the hollow mandrel in the direction of the first position under a pressure sufficient to inflate the flattened tubular film into a stiff generally circular cylindrical tube that makes a sliding fit with the mandrel and resists deformation during the helical cutting thereof, characterized by comprising moveable support means placed around the outside of the tubular film in a generally circular arrangement close upstream of or at the upstream end of the mandrel arranged to drive the cylindrical surface of the tube with an axial and circumferential component of movement aligned with the axial movement of the film and the rotation of the rotating unwind device.

20. The apparatus according to claim 19, wherein the moveable support means consist in a circular array of support devices which are mounted such that the array on the whole rotates with the same rotational velocity as that of the rotating unwind devices.

21. The apparatus according to claim 20, wherein the array and the rotating unwind devices form one integral stand.

22. The apparatus according to claim 20, wherein the array is mounted in a separate stand, which is brought to rotate synchronously with the rotating unwind devices.

23. The apparatus according to claim 20, further comprising
means for driving the support means, the driving means acting with a component of axial velocity greater than the axial velocity of the film at that point whereby the film slides on the driven support means.

24. The apparatus according to claim 19, wherein each support means is a wheel or short roller.

25. The apparatus according to claim 19, wherein each support means is a belt.

26. The apparatus according to claim 25, wherein the array of belts in the upstream end is arranged as a circular array.

27. The apparatus according to claim 25, wherein the array of belts in the upstream end is arranged as an oval array.

28. The apparatus according to claim 25, wherein the array of belts in the upstream end is arranged as two planar arrays facing each other and in close proximity to each other.

29. The apparatus according to claim 19, wherein at the position where the inflated film leaves the support means, the distance from middle to middle of each pair of adjacent support means is at the highest 30 cm.

30. The apparatus according to claim 19, wherein the upstream end of the mandrel is conical, and the conveying effect of the support means is confined to or ends in a zone over the conical part.

31. The apparatus according to claim 19, wherein the mandrel on the whole rotates with the same rotational velocity as the unwinding devices, while the cutting means are stationary.

32. The apparatus according to claim 19, wherein a downstream part of the mandrel including a conical end of the latter, rotates with the same rotational velocity as the rotating unwind devices, while the rest of the mandrel including the position where the cutting takes place, is stationary.

33. The apparatus according to claim 19, characterised in that the lay flat film to be used is a gusseted film, and in the expansion zone there are provided one or more conveyor straps arranged in each gusset against which the inside fold of the respective gusset bears, whereby the opening of the gusset is controlled.

34. The apparatus according to claim 19, further comprising
stretching rollers arranged to longitudinally stretch the film between the rotating unwind device and the expansion zone, wherein the stretching rollers are mounted to rotate with the unwind device and about the axis of the rotating unwind device.

35. The method according to claim 5, wherein each support means is driven by mechanical means different from the film itself, acting at a velocity which is higher than the velocity of the film, whereby the film slides on the support means.

36. The method according to claim 11, wherein at the position where the inflated film leaves the support means, the distance from middle to middle of each pair of adjacent support means is at the highest 20 cm.

37. The method according to claim 11, wherein at the position where the inflated film leaves the support means, the distance from middle to middle of each pair of adjacent support means is at the highest 10 cm.

38. The apparatus according to claim 29, wherein at the position where the inflated film leaves the support means, the distance from middle to middle of each pair of adjacent support means is at the highest 20 cm.

39. The apparatus according to claim 29, wherein at the position where the inflated film leaves the support means, the distance from middle to middle of each pair of adjacent support means is at the highest 10 cm.
